(19) United States
(12) Patent Application Publication
(10) Pub. No.: US 2009/0080112 A1
(43) Pub. Date: Mar. 26, 2009

(54) HARD DISK DRIVE MOUNTING METHOD, MAGNETIC BLOCK AND CLAMP DEDICATED FOR THE METHOD

(76) Inventor: Quan Chen, Guangdong Province (CN)

Correspondence Address: EAGLE IP LIMITED, 22/F., KWAI HUNG HOLDINGS CENTRE, 89 KING'S ROAD, NORTH POINT, HK

(21) Appl. No.: 12/159,628

(22) PCT Filed: Dec. 18, 2006
(86) PCT No.: PCT/CN2006/003452

§ 371 Date: Jun. 29, 2008

(30) Foreign Application Priority Data
Dec. 29, 2005 (CN) 200510121103.4

(51) Int. Cl. G11B 33/00; G11B 5/48

(52) U.S. Cl. 360/240; 29/603.04; G9B/33

(57) ABSTRACT

The method of the present invention for assembling a hard disk drive includes the following steps: 1) Position a head stack assembly onto a fixture; 2) position a magnetic block assembly onto the fixture; and 3) move the magnetic block assembly horizontally, making an upper and a lower magnetic blocks of the magnetic block assembly moved in place located at the upper and the lower sides of a coil of the head stack assembly, respectively. The magnetic block assembly of the hard disk drive dedicated for this assembling method includes the upper and the lower magnetic blocks, which are fixedly connected to form a whole, and between which there is a gap for accommodating the coil of the head stack assembly. The entire magnetic block assembly is moved to face the coil of the head stack assembly through a horizontal movement, and thus there is no need for a complicated fixture, making the assembling of the hard disk drive simpler and faster without damaging the disc.

### FIELD OF THE INVENTION

The present invention relates to the hard disk drive field, and particularly to a method for assembling a hard disk drive.

### BACKGROUND OF THE INVENTION

Before a prior hard disk drive is assembled, an upper and a lower magnetic blocks are positioned separately, and therefore such a hard disk drive is assembled according to the following steps: 1) First mount a disc, a head stack assembly and a lower magnetic block onto a hard disk drive base, respectively; 2) then mount the upper magnetic block assembly vertically onto a dedicated fixture, and overcome the attractive force between the upper and the lower magnetic blocks by actuating an air cylinder, making the upper magnetic block turn over to right above the lower magnetic block; and 3) then fix the upper and the lower magnetic blocks tightly together into a whole with screws. However, this assembling method has the following disadvantages: 1) The structure of the entire fixture is complicated, because the upper magnetic block needs to be driven to turn over from the vertical position to a horizontal position and to overcome the attractive force between the upper and the lower magnetic blocks; 2) it is not easy to control the end position of the movement of the upper magnetic block, and the driving force of the air cylinder; and 3) it is very liable to get the disc scratched during manual assembly of the upper and the lower magnetic blocks.

### SUMMARY OF THE INVENTION

The purpose of the present invention is to provide a method for assembling the hard disk drive, which is simple and will not get the hard disk disc damaged, as well as the dedicated magnetic block assembly and fixture thereof.

The purpose of the present invention is realized as below: The method for assembling the hard disk drive includes the following steps: 1) Position the head stack assembly onto the fixture; 2) position the magnetic block assembly onto the fixture; and 3) move this magnetic block assembly horizontally, making the upper and the lower magnetic blocks of the magnetic block assembly moved in place located at the upper and the lower sides of a coil of the head stack assembly, respectively.

The horizontal movement is a rotation movement in a horizontal plane.

The following step is also included before Step 2): The upper and the lower magnetic blocks are fixedly connected to form an integral magnetic block assembly.

The following step is also included after Step 3): Position the hard disk drive base onto the fixture, making the magnetic block assembly positioned in the mounting zone for the magnetic block assembly of this hard disk drive, and fix the head stack assembly tightly onto this hard disk drive base.

The magnetic block assembly of the hard disk drive dedicated for this assembling method includes the upper and the lower magnetic blocks, which are fixedly connected to form a whole, and between which is a gap for accommodating the coil of the magnetic head stack assembly.

The fixture dedicated for this assembling method includes a body and a positioning member located on the body and used for positioning the head stack assembly; and the body is further provided with a guide member for guiding the entire magnetic block assembly to move horizontally from a position away from the coil to a position right facing the coil.

The guide member includes a positioning pillar, which is used as a rotation axis when the entire magnetic block assembly rotates horizontally, and which is positioned protrudingly on the body. And the guide member further includes a limit face located at the end of the rotation track of the entire magnetic block assembly.

The positioning member for positioning the head stack assembly includes a pivot-shaft positioning needle and a head-arm positioning needle located alternatively.

The body is further provided with a cable-support positioning member for positioning the cable support.

The cable-support positioning member includes a first and a second support positioning needles located alternatively.

Compared with the prior art, the present invention has the following advantage: The entire magnetic block assembly is moved to face the coil of the head stack assembly through a horizontal movement, and thus there is no need for a complicated fixture, making the assembling of the hard disk drive simpler and faster without damaging the disc.

### BRIEF DESCRIPTION OF THE DRAWINGS

FIG. 1 is a stereoscopic drawing of the magnetic block assembly of the present invention.

FIG. 2 is a stereoscopic drawing of the fixture of the present invention.

FIG. 3 is a partial enlargement drawing of an area indicated by A in FIG. 2.

FIG. 4 is a stereoscopic drawing when the magnetic block assembly of the present invention is screwed into the head stack assembly.

FIG. 5 is a stereoscopic drawing after the magnetic block assembly of the present invention is completely screwed into the head stack assembly.

FIG. 6 is an assembling flow chart of the present invention.

### DETAILED DESCRIPTION OF THE EMBODIMENTS

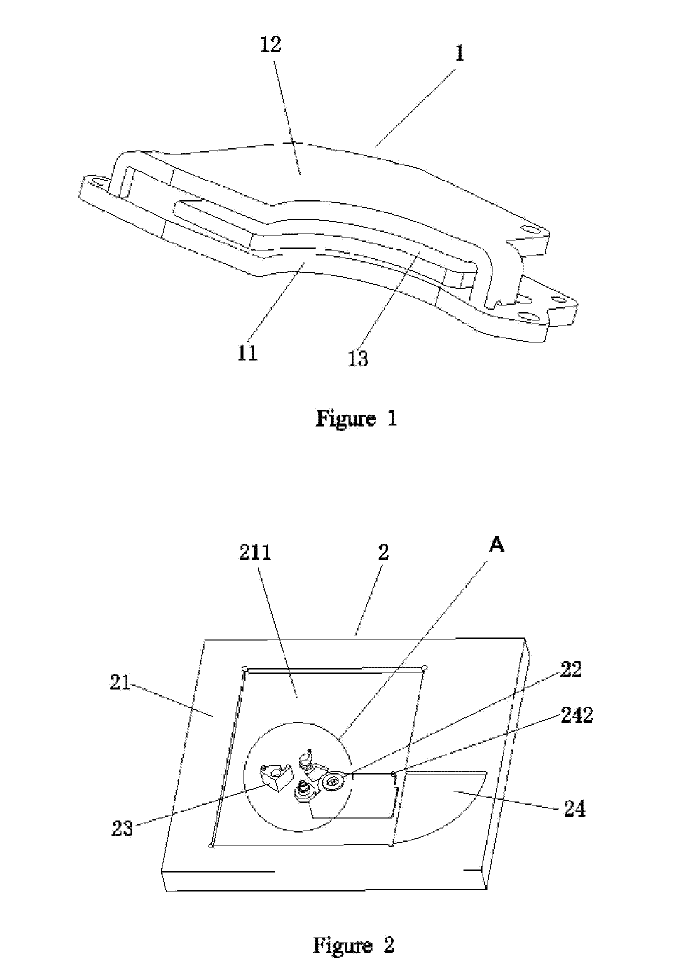

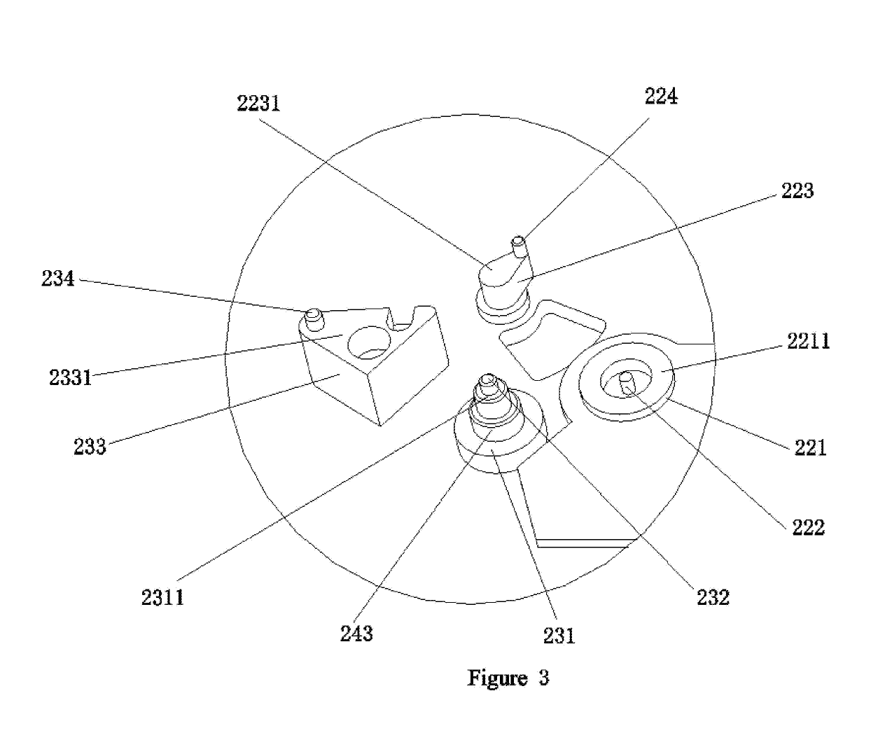

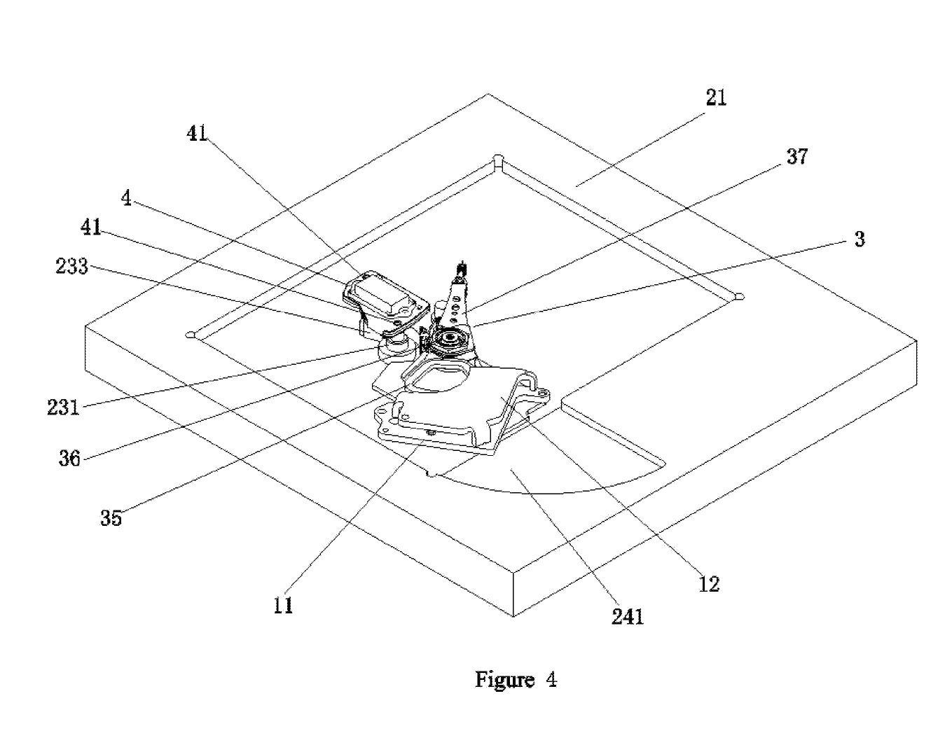

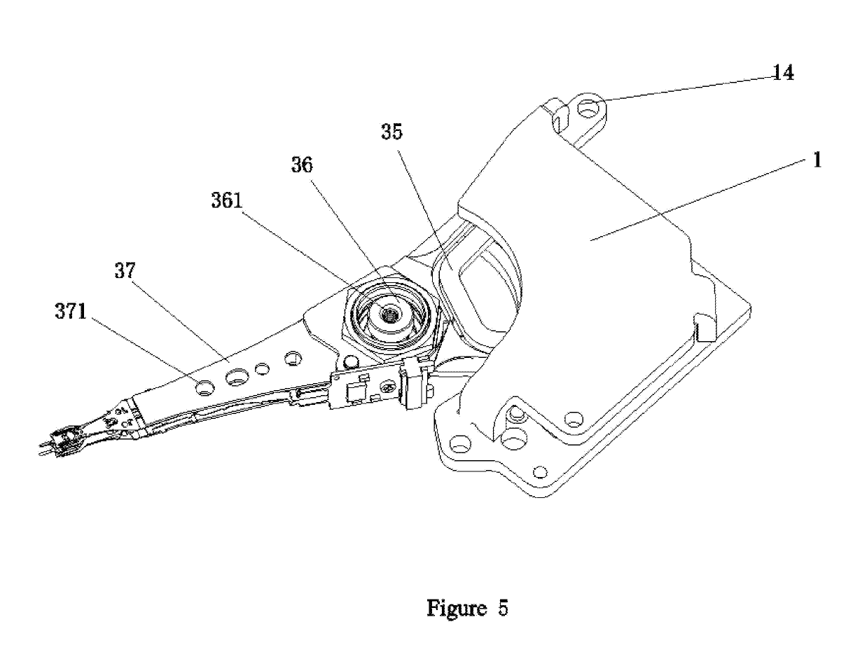

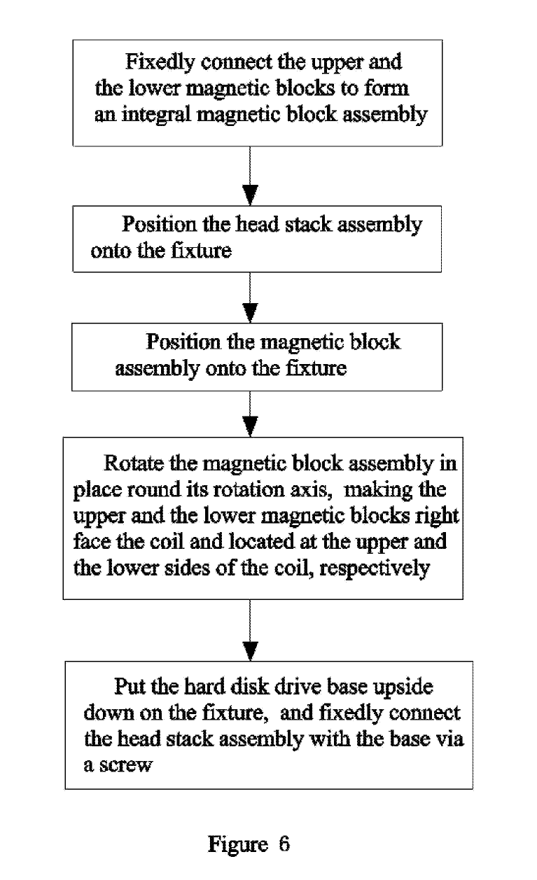

Referring to FIGS. 1 to 6, the method for assembling the hard disk drive of the present invention includes the following steps: 1) Fixedly connect the upper and the lower magnetic blocks 11 and 12 to form an integral magnetic block assembly 1; 2) position the head stack assembly 3 onto the fixture 2; 3) put the magnetic block assembly 1 in a designated position on the fixture 2, and then rotate the magnetic block assembly 1 horizontally by a certain angle, making the upper and the lower magnetic blocks 11 and 12 rotated in place right face a coil 35 of the head stack assembly and be positioned at the upper and the lower sides of this coil 35, respectively; and 4) put the hard disk drive base upside down on the fixture, and then put a screw through the base and make it fitted with a thread of a threaded mounting hole of the pivot shaft of the head stack assembly making the head stack assembly 3 fixed on the base.

The magnetic block assembly 1 dedicated for this assembling method includes the upper magnetic block 11 and the lower magnetic block 12, which are fixedly connected to form a whole, and between which is a gap 13 for accommodating the coil 35 of the head stack assembly 3.

The fixture 2 dedicated for this assembling method includes a body 21, a head-stack-assembly positioning member 22 positioned on the body 21, a cable-support positioning member 23, and a magnetic-block positioning member 24. In the center of the body 21 there is a base mounting seat 211 having a certain depth. The outline of the base mounting seat 211 matches with the exterior outline of the hard disk drive base, allowing the hard disk drive base to be positioned in the base mounting seat 211. The head-stack-assembly positioning member 22 includes a pivot-shaft bracing block 221, a pivot-shaft positioning needle 222, a head-arm bracing block 223, and a head-arm positioning needle 224. The pivot-shaft bracing block 221 has a ring form, protrudes vertically upward from the bottom wall of the base mounting seat 211, and has a support plane 2211 for supporting the pivot shaft 36. The pivot-shaft positioning needle 222 is located at the center of the ring bracing block 221, both sharing the same axis. This pivot-shaft positioning needle 222 is fitted with a female threaded hole or an unthreaded axle hole located on top of the pivot shaft 36, thus realizing positioning of the pivot shaft 36. The head-arm bracing block 223 is at a certain distance from the pivot-shaft bracing block 221, protrudes vertically upward from the bottom wall of the base mounting seat 211, and has a support plane 2231 for supporting the head-arm 37. The head-arm positioning needle 224 extends vertically from this support plane 2231, and is fitted with a through axle hole 371 in the head-arm 37. The head stack assembly 3 is positioned accurately onto the fixture 2 through the two-point positioning of this pivot-shaft positioning needle 222 and the head-arm positioning needle 224.

The cable-support positioning member 23 includes a first and a second support bracing blocks 231 and 233, on top of which are positioned support planes 2311 and 2331 for supporting the cable support 4.

The support planes 2311 and 2331 of the first and the second support bracing blocks are in the same plane.

From the support plane 2311 of the first support bracing block extends vertically upward a first-support positioning needle 232, and from the support plane 2331 of the second support bracing block a second-support positioning needle 234. The first and the second support positioning needles 232 and 234 are fitted with two positioning axle holes 41s in the cable support 4, these two positioning holes 41s being located diagonally.

The magnetic-block-assembly positioning member 24 is located outside the head-stack-assembly positioning member 22, and includes a magnetic-block-assembly mounting seat 241 and a magnetic-block-assembly positioning pillar 242. This magnetic-block mounting seat 241 has a form of ¼ circle. The magnetic-block positioning pillar 242 is positioned at the side of this mounting seat 241, and corresponding to position of a positioning hole 14 of the magnetic block assembly 1.

In this fixture, the relative positions among the head-stack-assembly positioning member, the cable-support positioning member, and the magnetic-block-assembly positioning member are consistent with those among the head stack assembly, the cable support, and the magnetic block assembly; and the distribution of the above-mentioned positioning members in the base mounting seat is the same with that of the head stack assembly, the cable support, and the magnetic block assembly in the hard disk drive base.

For assembling the hard disk drive, place the head stack assembly 3 onto the head-stack-assembly positioning member 22, make the pivot-shaft support plane 2211 and the head-arm support plane 2231 support this head stack assembly 3, and position the head stack assembly 3 accurately onto this fixture 2 through the pivot-shaft positioning needle 222 and the head-arm positioning needle 224; place the cable support 4 onto the first and the second support bracing blocks 231 and 233, and fit with the two positioning axle holes 41s in the cable support 4 through the first and the second support positioning needles 232 and 234, making the cable support 4 positioned accurately on this fixture 2; place the magnetic block assembly 1 onto the magnetic-block-assembly mounting seat 241, fit the magnetic-block-assembly positioning pillar 242 with the axle hole of the magnetic-block-assembly positioning hole 14, and then rotate the magnetic block assembly 1 clockwise, making the magnetic block assembly 1 rotate horizontally round this positioning pillar 242; the movement will terminate when during the rotation process the magnetic block assembly 1 contacts an outer wall 243 of the first support bracing block 231, and here the upper and the lower magnetic blocks 11 and 12 of the magnetic block assembly are right facing the head-stack-assembly coil 35 and positioned at the upper and the lower sides of this coil 35, respectively; after assembling the magnetic block assembly 1 onto the head stack assembly 3, put the hard disk drive base upside down on the base mounting seat 211, then fit it via a screw with thread of a threaded mounting hole 361 located on the bottom end of the pivot shaft 36, making the head stack assembly 3 fixed onto the hard disk drive base, and here the magnetic block assembly 1 and the cable support 4 are positioned accurately in a corresponding mounting area of the hard disk drive base; and finally take off this mounted hard disk drive from this fixture 2, and go through other existing steps for assembling the hard disk drive.

What is claimed is:

1. A method for assembling a hard disk drive, wherein it comprises the following steps:
1) position a head stack assembly onto a fixture;
2) position a magnetic block assembly onto the fixture; and
3) move the magnetic block assembly horizontally, making an upper and a lower magnetic blocks of the magnetic block assembly moved in place located at an upper and a lower sides of a coil of the head stack assembly, respectively.

2. The method for assembling the hard disk drive according to claim 1, wherein the horizontal movement is a rotation movement in a horizontal plane.

3. The method for assembling the hard disk drive according to claim 1 or 2, wherein the following step is also included before Step 2): the upper and the lower magnetic blocks are fixedly connected to form an integral magnetic block assembly.

4. The method for assembling the hard disk drive according to claim 1 or 2, wherein the following step is also included after Step 3): position the hard disk drive base onto the fixture, making the magnetic block assembly positioned in a mounting zone for the magnetic block assembly of this hard disk drive, and fix the head stack assembly tightly onto this hard disk drive base.

5. A magnetic block assembly of the hard disk drive dedicated for the assembling method according to claim 1, wherein the magnetic block assembly includes the upper and the lower magnetic blocks, which are fixedly connected to form a whole, and between which is a gap for accommodating the coil of the head stack assembly.

6. A fixture dedicated for the assembling method according to claim 1, wherein the fixture includes a body as well as a positioning member located on the body and used for positioning the head stack assembly, the body being further provided with a guide member for guiding the entire magnetic block assembly to move horizontally from a position away from the coil to a position right facing the coil.

7. The fixture according to claim 6, wherein the guide member includes a positioning pillar, which is used as a rotation axis when the entire magnetic block assembly rotates horizontally and positioned protrudingly on the body; and the guide member further includes a limit face located at the end of rotation track of the entire magnetic block assembly.

8. The fixture according to claim 6 or 7, wherein the positioning member for positioning the head stack assembly includes a pivot-shaft positioning needle and a head-arm positioning needle located alternatively.

9. The fixture according to claim 6 or 7, wherein the body is further provided with a cable-support positioning member for positioning the cable support.

10. The fixture according to claim 9, wherein the cable-support positioning member includes a first and a second support positioning needles located alternatively.
